(19) United States
(12) Patent Application Publication
(10) Pub. No.: US 2026/0273970 A1
(43) Pub. Date: Sep. 17, 2026

(54) SHEET CONVEYANCE APPARATUS, IMAGE FORMING APPARATUS AND IMAGE FORMING SYSTEM

(71) Applicant: CANON KABUSHIKI KAISHA, Tokyo (JP)

(72) Inventor: MASAYUKI HIRANO, Chiba (JP)

(21) Appl. No.: 19/445,343

(22) Filed: Jan. 9, 2026

(30) Foreign Application Priority Data
Jan. 21, 2025 (JP) 2025-008420

(51) Int. Cl. B41J 13/00; B41J 13/02; B41J 13/26

(52) U.S. Cl. CPC B41J 13/0027; B41J 13/02; B41J 13/26; B41J 2203/01

(57) ABSTRACT

In a case where an edge portion of a sheet is positioned within a detection range of a single sensor chip in a state where a reference position of the sheet is moved to a first target value, a control unit is configured to move the reference position of the sheet toward the first target value. In a case where an edge portion of a sheet is not positioned within a detection range of a single sensor chip in a state where a reference position of the sheet is moved to the first target value, the control unit is configured to move the reference position of the sheet toward a second target position offset from the first target. The second target position is a position where the edge portion of the sheet is positioned within the detection range of a single sensor chip.

### BACKGROUND

### Field of the Technology

The present disclosure relates to a sheet conveyance apparatus that moves a width direction position of a sheet, an image forming apparatus, and an image forming system.

### Description of the Related Art

In sheet conveyance apparatuses equipped in an image forming system for forming images on sheets, there may be a state where a sheet being conveyed is displaced from a desirable conveyance position due to skewing of the conveyed sheet, for example. Therefore, a technique is proposed in which an edge portion of a sheet in a width direction is detected by a contact image sensor (CIS), and based on the detection result thereof, the sheet is moved to correct the position of the sheet (refer to Japanese Patent Application Laid-Open Publication No. 2017-202916).

The CIS as described above is configured by aligning a plurality of sensor chips, each sensor chip including a plurality of light receiving elements arranged in an aligned manner, in a width direction orthogonal to a sheet conveyance direction. However, there are errors in a spacing between the plurality of sensor chips that are aligned in the width direction, and in a case where the edge portions of the sheet are detected by different sensor chips, an accuracy of the position being detected is not good because of the error, such that the positional accuracy of the sheet that has been moved is also not good. If the positional accuracy of the sheet is not good, the positional accuracy of the image being formed on the sheet thereafter is also not good.

### SUMMARY

The present disclosure provides a sheet conveyance apparatus and an image forming apparatus capable of realizing a good positional accuracy of the image being formed on a sheet.

According to one aspect of the present disclosure, a sheet conveyance apparatus includes a moving unit including a roller configured to convey a sheet, the moving unit being configured to move a position of the sheet in a width direction orthogonal to a conveyance direction, a width position detection unit including a plurality of sensor chips aligned in the width direction, each sensor chip including a plurality of light receiving elements, the width position detection unit being configured to detect a position of an edge portion of the sheet in the width direction, and a control unit configured to execute a movement process of moving a reference position of a sheet toward a first target position of a sheet conveyance path in the width direction according to a detection result of the width position detection unit. In a case where an edge portion of a sheet is positioned within a detection range of a single sensor chip in a state where a reference position of the sheet is moved to a first target value, the control unit is configured to move the reference position of the sheet toward the first target value by the moving unit according to the detection result of the width position detection unit. In a case where an edge portion of a sheet is not positioned within a detection range of a single sensor chip in a state where a reference position of the sheet is moved to the first target value, the control unit is configured to move the reference position of the sheet toward a second target position offset from the first target value by the moving unit according to the detection result of the width position detection unit. The second target position is a position where the edge portion of the sheet is positioned within the detection range of a single sensor chip.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating a schematic configuration of an inkjet recording system according to the present embodiment.

FIG. 2 is a top view illustrating a registration unit of a print module according to the present embodiment.

FIG. 3 is a perspective view of the registration unit of the print module according to the present embodiment.

FIG. 4A is a perspective view of the registration unit prior to turning a registration driving roller.

FIG. 4B is a perspective view of the registration unit after turning the registration driving roller.

FIG. 5A is a top view of the registration unit prior to conveying a sheet.

FIG. 5B is a top view of the registration unit in a state where skew correction of a sheet is performed.

FIG. 5C is a top view of the registration unit in a state where lateral registration correction of a sheet is performed.

FIG. 6 is a lateral cross-sectional view of a registration unit of a print module according to the present embodiment.

FIG. 7A is a schematic diagram of a measurement example of a skewing amount.

FIG. 7B is a view illustrating an example of a skew correction profile.

FIG. 7C is a schematic diagram of a skew correction operation.

FIG. 8A is a schematic diagram of a measurement example of a lateral registration displacement amount.

FIG. 8B is a view illustrating an example of a lateral registration displacement correction profile.

FIG. 8C is a schematic diagram illustrating a lateral registration displacement correction operation.

FIG. 9 is a view illustrating an example of a correction profile when performing the lateral registration displacement correction.

FIG. 10 is an explanatory view illustrating a conversion of a velocity component and an angle component of a registration driving roller in a case where skew correction and lateral registration displacement correction are performed at the same time.

FIG. 11 is a view illustrating an example of a correction profile in a case where skew correction and lateral registration displacement correction are performed at the same time.

FIG. 12 is an explanatory view illustrating a detection operation of a position of a side edge of a sheet by an image sensor according to the present embodiment.

FIG. 13A is a view illustrating a case where a side edge position of a sheet is dispersed within a detection range of a single sensor chip in a CIS.

FIG. 13B is a view illustrating a case where a side edge position of a sheet is dispersed across different sensor chips in a CIS.

FIG. 14 is a block diagram illustrating a configuration of a control system according to the present embodiment.

FIG. 15A is an explanatory view illustrating a case where a sheet position is moved with a conveyance center line position set as a target in a first correction control.

FIG. 15B is an explanatory view illustrating a case where a sheet position is moved with the conveyance center line position set as a target in a second correction control.

FIG. 15C is an explanatory view illustrating a case where a sheet position is moved with an offset position offset from the conveyance center line position set as a target in the first correction control.

FIG. 15D is an explanatory view illustrating a case where a sheet position is moved with an offset position offset from the conveyance center line position set as a target in the second correction control.

FIG. 16 is a flowchart illustrating a control of a registration unit according to the present embodiment.

FIG. 17 is a flowchart illustrating a control of a recording unit according to the present embodiment.

### DESCRIPTION OF THE EMBODIMENTS

Embodiments for carrying out the present disclosure will be described below with reference to the drawings. In the present embodiment, a case is described where an inkjet recording system 1 is applied as an image forming system.

### Inkjet Recording System

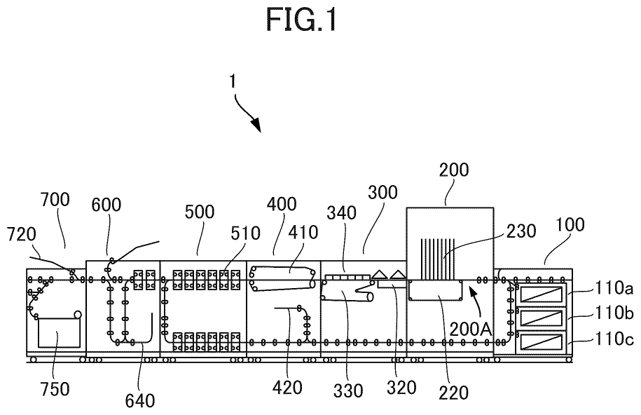

First, a schematic configuration of the inkjet recording system 1 according to the present embodiment will be described with reference to FIG. 1. FIG. 1 is a schematic diagram illustrating a schematic configuration of the inkjet recording system 1 according to the present embodiment. The inkjet recording system 1 serving as an image forming system is a sheet-type inkjet recording system that creates a recorded matter in which an ink image is formed on a sheet S using two liquids, a reaction liquid and ink. As illustrated in FIG. 1, the inkjet recording system 1 is composed of a feeding module 100, a printing module 200, a drying module 300, a fixing module 400, a cooling module 500, a reversing module 600, and a discharging module 700. The sheet S in a state of cut paper supplied from the feeding module 100 is conveyed along a conveyance path, subjected to processing in each module, and discharged by the discharging module 700 serving as a sheet supporting apparatus. Further according to the inkjet recording system 1, an image is formed on a sheet at the printing module 200 serving as an image forming apparatus, and the sheet on which the image has been formed is subjected to various processing at a position downstream of the printing module 200 in a conveyance direction of the sheet. Therefore, the drying module 300, the fixing module 400, the cooling module 500, the reversing module 600, and the discharging module 700 can also be referred to as processing apparatuses.

The feeding module 100 includes three storages 110a, 110b, and 110c that store the sheets S. Storages 110a, 110b, and 110c are each configured to be drawn out to a front side of the apparatus. The sheets S are fed one by one by a separation belt and a conveyance roller not shown in each of the storages 110a, 110b, and 110c, and conveyed to the printing module 200. The number of storages 110a, 110b, and 110c is not limited to three, and the number may be one, two, or even four or more.

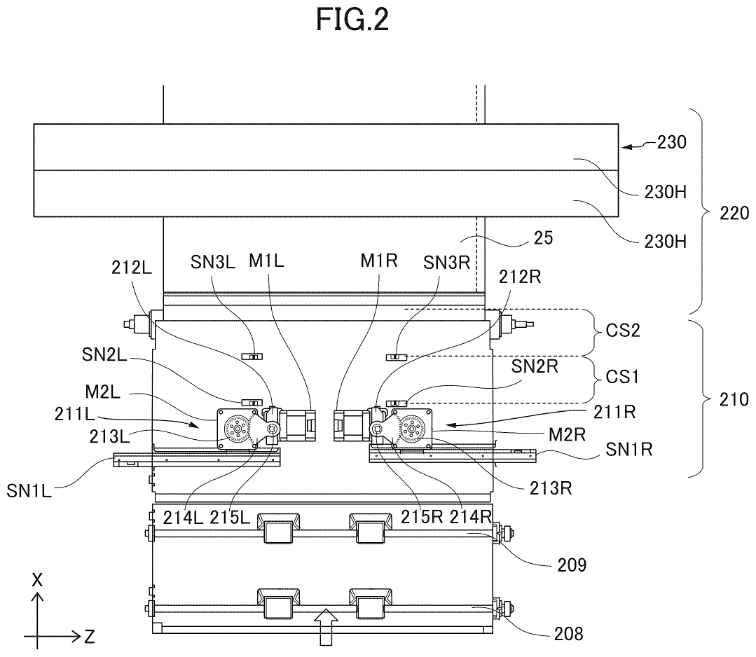

The printing module 200 includes a registration unit 210 (refer to FIG. 2) serving as a correction unit that performs skew correction and lateral registration correction prior to creating an image as described in detail later, a print belt unit 220, and a recording unit 230. The sheet S conveyed from the feeding module 100 is subjected to sheet inclination and position correction by a plurality of conveyance roller pairs 208 and 209 (refer to FIG. 2) serving as a conveyance unit and the registration unit 210, and conveyed to the print belt unit 220. The recording unit 230 is arranged at a position facing the print belt unit 220 with respect to the conveyance path. The plurality of the conveyance roller pairs 208 and 209 and the registration unit 210 constitute a sheet conveyance unit 200A serving as a sheet conveyance apparatus that conveys the sheet to the recording unit 230. Further, the recording unit 230 constitutes an image forming unit that forms an image by performing a recording process, i.e., printing, to the sheet S from above the sheet S being conveyed via a plurality of recording heads 230H (refer to FIG. 2).

The plurality of recording heads 230H are aligned along a conveyance direction of the sheet, which is hereinafter referred to simply as the conveyance direction. In the present embodiment, a total of five line-type recording heads, corresponding to four colors of yellow (Y), magenta (M), cyan (C), and black (Bk), and to a reaction liquid. The number of colors and the number of recording heads are not limited to five. An inkjet system may adopt a heat generating element system, a piezoelectric element system, a capacitance element system, and a MEMS element system. The inks of various colors are supplied from an ink tank not shown via respective ink tubes to the recording heads. The sheet S to which printing is performed by the recording unit 230 is attracted to and conveyed on the print belt unit 220, by which the sheet S is conveyed while ensuring a clearance from the recording head. The sheet S to which printing is performed by the recording unit 230 is subjected to detection of displacement or color density of the image formed on the sheet S by an inline scanner not shown disposed downstream of the recording unit in the conveyance direction. The result of detection is used to correct the image to be printed.

The drying module 300 includes a decoupling unit 320, a drying belt unit 330, and a hot air blow unit 340, and reduces the liquid portion included in the ink applied to the sheet S by the recording unit 230 of the printing module 200 and enhances the fixing performance of the sheet S and the ink. The sheet S printed by the recording unit 230 of the printing module 200 is conveyed to the decoupling unit 320 arranged upstream of the drying module 300 in the conveyance direction. In the decoupling unit 320, the sheet S is conveyed by wind pressure from the upper direction and friction of the belt, and by conveying the sheet S on the belt while holding the sheet with a weak force, the displacement of the sheet S on the print belt unit 220 forming the ink image may be prevented. The drying belt unit 330 is arranged below the belt and the hot air blow unit 340 is arranged above the belt, wherein the units are arranged to face each other with the belt interposed therebetween. The sheet S conveyed from the decoupling unit 320 is attracted to and conveyed on the drying belt unit 330, and at the same time, receives hot air blow from the hot air blow unit 340, by which the ink application surface is dried. The drying system may be composed by combining, other than the hot air applying system, a system in which electromagnetic waves, such as ultraviolet or infrared light, are irradiated on the surface of the sheet S, and a conductive heat transfer system adopting contact of a heating element.

The fixing module 400 includes a fixing belt unit 410. The fixing belt unit 410 includes an upper belt unit and a lower belt unit, and by passing the sheet S conveyed from the drying module 300 between the heated upper belt unit and lower belt unit, the ink is fixed onto the sheet S.

The cooling module 500 includes a plurality of cooling portions 510, and cools the heated sheet S conveyed from the fixing module 400. Each cooling portion 510 takes in outer air via fans into a cooling box, increasing the pressure within the cooling box, and blows the air discharged through nozzles formed on the conveyance guide onto the sheet S, thereby cooling the sheet S. The cooling portions 510 are disposed on both upper and lower sides of the conveyance path, cooling the sheet S from both sides.

The cooling module 500 includes a conveyance path switching portion, and the conveyance path of the sheet S can be switched according to a case where the sheet S is conveyed to the reversing module 600 and a case where the sheet S is conveyed to a duplex conveyance path used for performing duplex printing. During duplex printing, the sheet S is conveyed to a conveyance path on the lower portion of the cooling module 500. In this case, the sheet is further conveyed from the cooling module 500 along the duplex conveyance path via the fixing module 400, the drying module 300, the printing module 200, and the feeding module 100. A first reverse portion 420 for reversing the upper and lower sides of the sheet S is disposed on the duplex conveyance path of the fixing module 400. Then, the sheet S is conveyed again from the feeding module 100 to a pre-image-forming registration correction unit, the print belt unit 220, and the recording unit 230 of the printing module 200, and subjected to printing at the recording unit 230.

The reversing module 600 includes a second reverse portion 640, by which the upper and lower surfaces of the sheet S being conveyed may be reversed, such that the upper and lower sides of the sheet S being discharged may be changed. The discharging module 700 includes a top tray 720 and a supporting portion 750, and the sheet S conveyed from the reversing module 600 can be aligned and stacked on the top tray 720 or the supporting portion 750, or can be discharged onto an external tray not shown.

### Configuration of Registration Unit of Print Module and Periphery Thereof

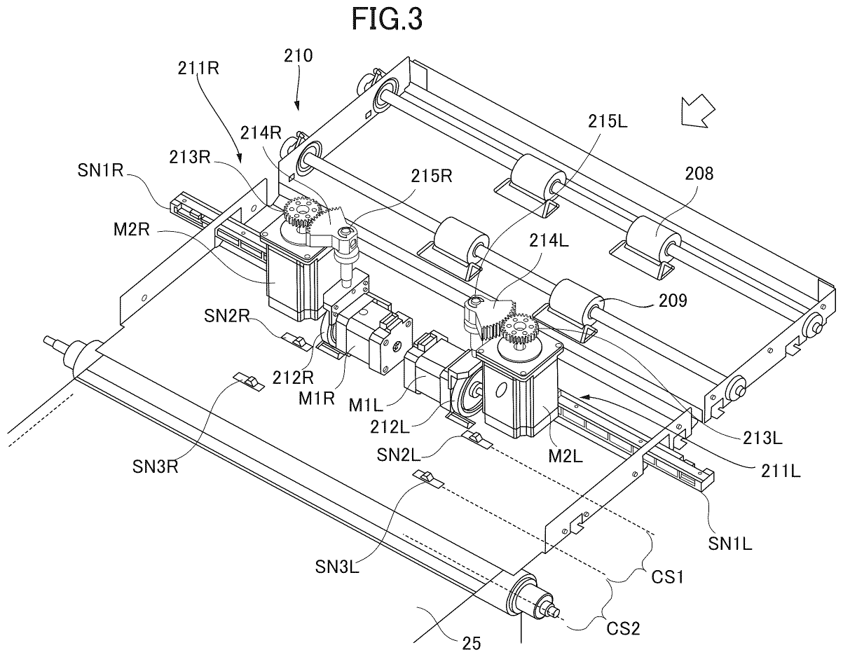

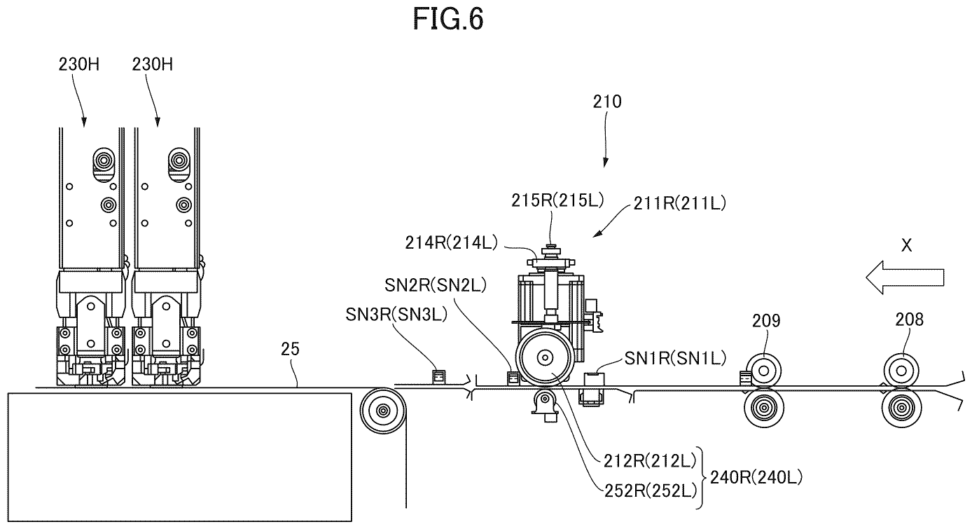

Next, a configuration of the registration unit 210 of the printing module 200 and a periphery thereof will be described with reference to FIGS. 2, 3, and 6. FIG. 2 is a top view of the registration unit of the print module according to the present embodiment. FIG. 3 is a perspective view of the registration unit of the print module according to the present embodiment. FIG. 6 is a lateral cross-sectional view of the registration unit of the print module according to the present embodiment.

In the printing module 200, as illustrated in FIGS. 2 and 3, the conveyance roller pairs 208 and 209 that convey the sheets are arranged in order in a conveyance direction X in the sheet conveyance unit 200A (refer to FIG. 1). The conveyance roller pairs 208 and 209 include, for example, a lower roller including a roller made of EPDM, and an upper roller which is a rubber roller made of urethane, wherein the lower roller is urged toward the upper roller by a spring not shown. In this description, the conveyance direction X refers to a direction in a case where the sheet S is not skewed, and does not refer to the conveyance direction according to a steering operation described later.

Further, in the sheet conveyance unit 200A of the printing module 200, the registration unit 210 serving as a correction unit is arranged downstream of the conveyance roller pairs 208 and 209 in the conveyance direction X. That is, the registration unit 210 corrects the position of the sheet being conveyed by the conveyance roller pairs 208 and 209. Further, in the printing module 200, the print belt unit 220 is arranged downstream of the registration unit 210 in the conveyance direction X. The print belt unit 220 includes a print belt 25 rotated in a manner attracting and conveying the sheet thereon, and the recording unit 230, that is, the plurality of recording heads 230H (refer to FIG. 2), for forming an image on the sheet being conveyed by the print belt 25.

### Registration Roller Pair

The registration unit 210 includes, as illustrated in FIG. 6, a left registration roller pair, hereinafter simply referred to as “registration roller pair”, 240L on a left side of a conveyance center line (refer to FIG. 2) with respect to the sheet conveyance direction X. Further, the registration unit 210 includes a right registration roller pair, hereinafter simply referred to as “registration roller pair” 240R in a manner arranged in parallel on a right side of the conveyance center line (refer to FIG. 2) with respect to the conveyance direction X. The registration roller pair 240L includes a registration driving roller 212L serving as a sheet moving unit or a first skew correction roller, and a registration follower roller 252L that is arranged to face the registration driving roller 212L and that is driven to rotate when it is in contact therewith. Similarly, the registration roller pair 240R includes a registration driving roller 212R serving as a sheet moving unit or a second screw correction roller, and a registration follower roller 252R that is arranged to face the registration driving roller 212R and that is driven to rotate when it is in contact therewith. Further, the registration driving rollers 212L and 212R are each formed of a rubber roller made of polyurethane, and the registration follower rollers 252L and 252R are each formed of a roller made of EPDM. The registration follower rollers 252L and 252R of the registration roller pairs 240L and 240R are movable between a contact position in contact with the registration driving rollers 212L and 212R and a separation position separated therefrom by a separation mechanism not shown.

### Turning Mechanism

Next, turning mechanisms 211L and 211R in the registration unit 210 will be described. As illustrated in FIGS. 2 and 3, the registration unit 210 includes the turning mechanisms 211L and 211R that drive to rotate and turn each of the registration driving rollers 212L and 212R. Each of the turning mechanisms 211L and 211R includes a registration driving motor M1L serving as a first rotational driving motor and a registration driving motor M1R serving as a second rotational driving motor. Further, each of the turning mechanisms 211L and 211R incudes a steering motor M2L serving as a first turning motor and a steering motor M2R serving as a second turning motor. Further, each of the turning mechanisms 211L and 211R includes motor gears 213L and 213R that transmit rotation of the steering motors M2L and M2R, drive input gears 214L and 214R, and steering shafts 215L and 215R.

The rotation shafts of each of the registration driving motors M1L and M1R are connected to transmit driving force to the registration driving rollers 212L and 212R. That is, the registration driving rollers 212L and 212R are driven to rotate such that rotational speeds of each of the registration driving rollers 212L and 212R can be changed independently by the rotation of the registration driving motors M1L and M1R.

Each of the steering shafts 215L and 215R rotatably support frames 216L and 216R (refer to FIG. 3) that respectively support each of the registration driving rollers 212L and 212R and the registration driving motors M1L and M1R. In other words, the registration driving rollers 212L and 212R and the registration driving motors M1L and M1R are supported rotatably, i.e., turnably, about the steering shafts 215L and 215R whose axial direction is an intersecting direction intersecting, i.e., orthogonal to, the conveyance direction X and a width direction Z orthogonal to the conveyance direction X.

Meanwhile, the steering motors M2L and M2R are each arranged along an axial direction parallel to the axial direction of the steering shafts 215L and 215R, and the motor gears 213L and 213R are fixed to each of the rotation shafts. The drive input gears 214L and 214R fixed to each of the steering shafts 215L and 215R are meshed with each of the motor gears 213L and 213R. By rotating the steering motors M2L and M2R, the registration driving rollers 212L and 212R and the registration driving motors M1L and M1R are turned, i.e., rotated, about the steering shafts 215L and 215R.

In other words, the registration driving rollers 212L and 212R are configured to be driven to rotate by the registration driving motors M1L and M1R and to turn by the steering motors M2L and M2R in a direction inclined with respect to the conveyance direction X. Thereby, conveyance velocities of the registration roller pairs 240L and 240R can be changed independently, and the conveyance directions thereof can also be changed independently.

Further, home position sensors not shown are arranged in the vicinity of each of the registration driving rollers 212L and 212R, and the home position sensors detect home positions of the registration driving rollers 212L and 212R. The home positions of the registration driving rollers 212L and 212R are positions where the registration roller pairs 240L and 240R are disposed straight, without being inclined, with respect to the conveyance direction. That is, the registration roller pairs 240L and 240R are configured to be returned to positions where they are not inclined with respect to the conveyance direction based on the detection of the home position sensors.

### Configuration of Skew Detection of Sheet

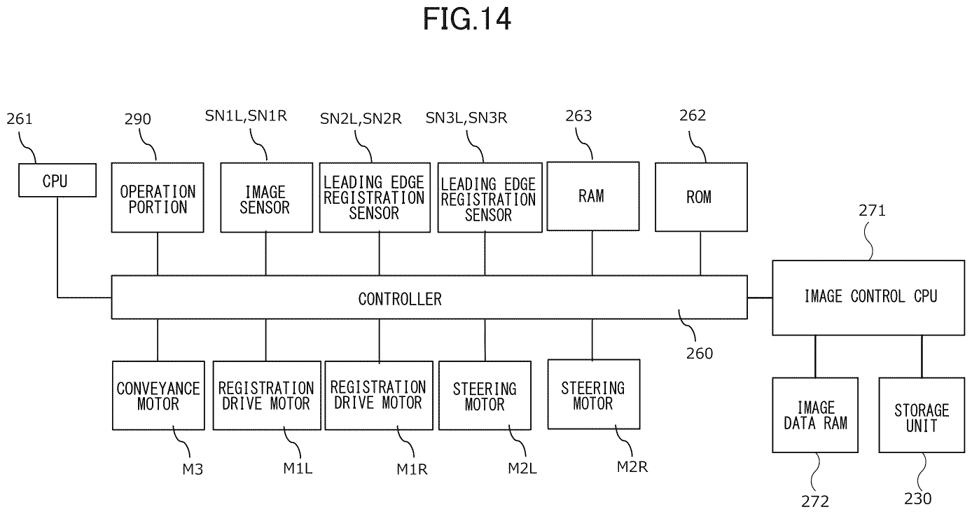

Leading edge registration sensors SN2L and SN2R serving as a skew detection unit or a first skewing amount detection unit composed of optical sensors, for example, are disposed at the same positions in the conveyance direction X, that is, aligned in the width direction Z, at positions near nips of each of the registration roller pairs 240L and 240R. That is, the leading edge registration sensors SN2L and SN2R are arranged immediately downstream of the registration roller pairs 240L and 240R in the conveyance direction X. A controller 260 (refer to FIG. 14) serving as a control unit described later computes the skewing amount of the sheet S from a difference in timing at which each of the leading edge registration sensors SN2L and SN2R detected a leading edge of the sheet S and a conveyance velocity in which the sheet S is conveyed.

Similarly, leading edge registration sensors SN3L and SN3R serving as a skew detection unit or a second skewing amount detection unit composed of optical sensors, for example, are disposed downstream of the leading edge registration sensors SN2L and SN2R in the conveyance direction X. Similarly, the controller 260 (refer to FIG. 14) computes the skewing amount of the sheet S from a difference in timing at which each of the leading edge registration sensors SN3L and SN3R detected the leading edge of the sheet S and a conveyance velocity in which the sheet S is conveyed. That is, the leading edge registration sensors SN3L and SN3R detect the skewing amount of the sheet at a second position conveyed downstream in the conveyance direction X from a first position of the sheet where skewing amount of the sheet has been detected by the leading edge registration sensors SN2L and SN2R. A section from where the leading edge of the sheet is detected by the leading edge registration sensors SN2L and SN2R to where the leading edge of the sheet reaches the leading edge registration sensors SN3L and SN3R is referred to as a first correction section CS1 where a first correction control serving as a first movement process described later is performed. Further, a section from where the leading edge of the sheet is detected by the leading edge registration sensors SN3L and SN3R to where the leading edge of the sheet reaches the print belt 25 is referred to as a second correction section CS2 where a second correction control serving as a second movement process described later is performed.

### Configuration of Width Direction Position Detection of Sheet

Contact image sensors (CIS), hereinafter simply referred to as “image sensors”, SN1L and SN1R serving as width position detection units are arranged upstream of each of the registration roller pairs 240L and 240R in the conveyance direction X. The image sensor SN1L serving as a first width position detecting sensor detects an edge position of a left edge portion of the sheet S, and the image sensor SN1R serving as a second width position detecting sensor detects an edge portion of a right edge position of the sheet S. That is, the image sensor SN1L is arranged on one side of the conveyance center line in the width direction Z, and the image sensor SN1R is arranged on the other side of the conveyance center line in the width direction Z. The image sensors SN1L and SN1R detect the width direction position of the sheet S based on the edge positions of the left edge portion and the right edge portion of the sheet, and the controller 260 (refer to FIG. 14) computes a displacement amount, so-called a lateral registration displacement position, of the width direction position based on the detection result. The detailed configuration of the image sensor SN1L or SN1R will be described below.

The image sensors SN1L and SN1R are arranged at positions such that width direction positions of the sheet ma be detected when leading edges of a minimum size sheet that may be conveyed in the printing module 200 reaches the leading edge registration sensors SN3L and SN3R. In other words, the displacement amount of the sheet in the width direction position can be detected both in a state where the skewing amount is detected when the sheet is at the first position and in a state where the skewing amount is detected when the sheet is at the second position. Thereby, regardless of the size of the sheet being conveyed, the sheet skewing amount and the width direction position at the first position and the sheet skewing amount and the width direction position at the second position can be detected.

### Configuration of Control System of Print Module

Next, a configuration of a control system in the printing module 200 will be described with reference to FIG. 14. FIG. 14 is a block diagram illustrating a configuration of a control system according to the present embodiment.

As illustrated in FIG. 14, the controller 260 that functions as a control unit is connected to a CPU 261, a ROM 262, and a RAM 263, and programs stored in the ROM 262 can be executed by the CPU 261 using storage areas of the RAM 263. Further, the controller 260 is connected to an operation portion 290, such as an operation panel not illustrated in FIG. 1, and to an external computer via an interface not shown, through which various input operations are received or on which results are displayed.

Further, the controller 260 is connected to various sensors including the above-mentioned image sensors SN1L and SN1R, the first leading edge registration sensors SN2L and SN2R, and the second leading edge registration sensors SN3L and SN3R. The controller 260 is also connected to various motors including the above-mentioned registration driving motors M1L and M1R, the steering motors M2L and M2R, and a conveyance motor M3 that drives the conveyance roller pairs 208 and 209. The controller 260 controls the various motors based on the detection results of the various sensors, conveys the sheets, and executes a correction control including both skew correction described in detail below and a lateral registration displacement correction serving as a width position correction.

An image control CPU 271 is connected to the controller 260 via a system bus. The image control CPU 271 reads out image data from an image data RAM 272, and controls the recording unit 230 to form an image on the sheet S. As descried in detail later, when shifting a center position Pc of the sheet, the image control CPU 271 receives a shift amount from the CPU 261, and based on the received shift amount information, performs adjustment, or shift, of image data output to the recording unit 230. By the image control CPU 271 performing adjustment of image data to be output to the recording unit 230, an image can be formed on a preferred position on the sheet S even when the sheet S is shifted and conveyed.

### Skew Correction Operation

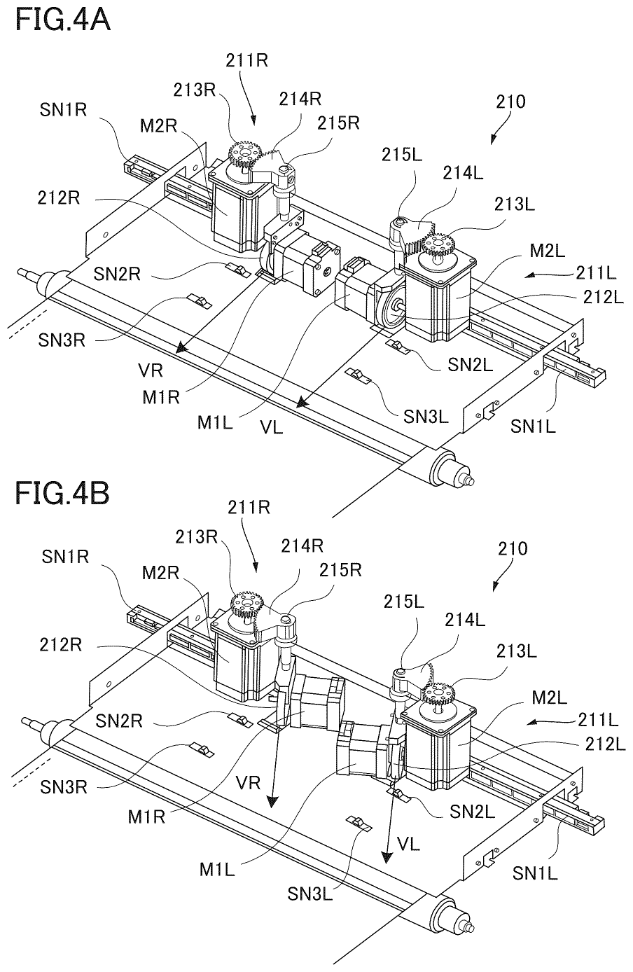

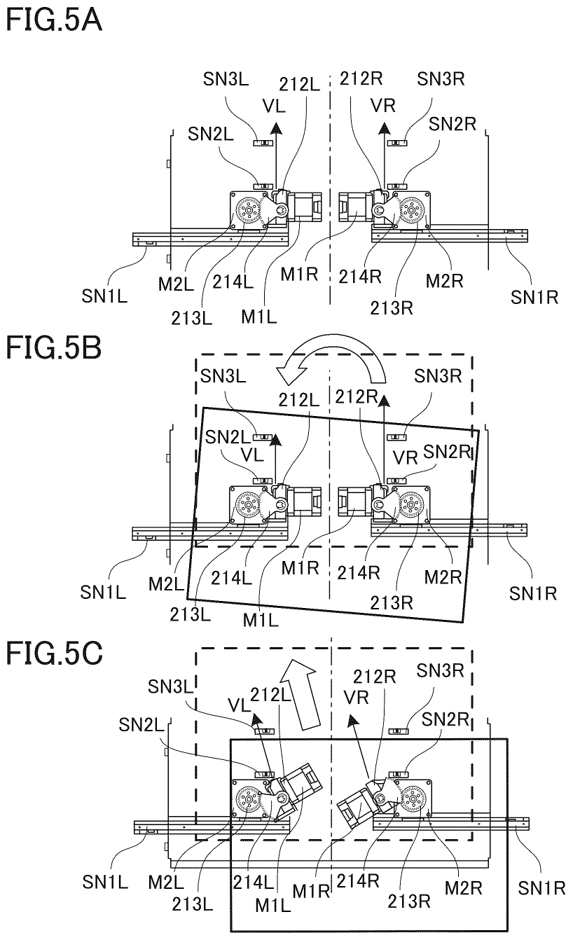

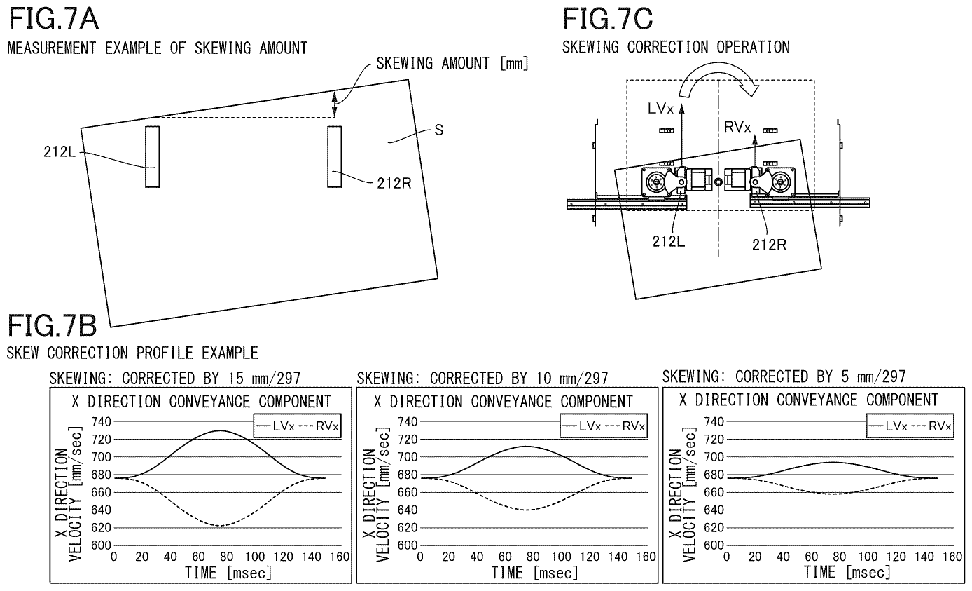

Next, a principle of skew correction operation, i.e., active registration operation, will be described with reference to FIGS. 4A, 4B, 5A, 5B, 5C, 7A, 7B, and 7C. FIG. 4A is a perspective view illustrating a registration unit prior to turning a registration driving roller. FIG. 4B is a perspective view illustrating the registration unit after turning the registration driving roller. FIG. 5A is a top view illustrating the registration unit prior to conveyance of a sheet. FIG. 5B is a top view illustrating the registration unit in a state where skew correction of the sheet is performed. FIG. 5C is a top view illustrating the registration unit in a state where lateral registration correction of the sheet is performed. FIG. 7A is a schematic diagram illustrating a measurement example of a skewing amount. FIG. 7B is a view illustrating an example of skew correction profile. FIG. 7C is a schematic diagram illustrating a skew correction operation. Skew correction refers to correcting an angle of travelling direction of the sheet such that it is in a direction parallel to a conveyance center line which is a center of a conveyance path in a width direction through which the sheet is conveyed.

In the registration unit 210, as described above, the registration driving rollers 212L and 212R are independently driven by the registration driving motors M1L and M1R, such that the rotational speeds thereof can be changed independently. The controller 260 determines a skew correction profile for correcting skewing of a sheet based on an inclination angle of a sheet detected by the leading edge registration sensors SN2L and SN2R or the leading edge registration sensors SN3L and SN3R. The skew correction profile is a control amount for controlling a velocity difference of the registration driving rollers 212L and 212R. Then, the controller 260 drives the registration driving motors M1L and M1R based on the skew correction profile, and rotates the registration driving rollers 212L and 212R.

The skew correction profile will be described below. For example, as illustrated in FIGS. 4A and 5A, in a state where skew correction is not performed, the registration driving rollers 212L and 212R face the conveyance direction X, and are rotated by same velocities VL and VR to convey the sheet. The sheet is conveyed, and as illustrated in FIGS. 4B and 7A, for example, the skewing amount of the sheet is detected by the leading edge registration sensors SN2L and SN2R. Then, the controller 260 creates a skew correction profile as illustrated in FIG. 7B according to the detected skewing amount. The skew correction profile is created as a velocity table such that the skewing amount detected by the leading edge registration sensors SN2L and SN2R and a difference between an integrated value of a velocity LVx of the registration driving roller 212L and an integrated value of a velocity RVx of the registration driving roller 212R are equivalent. That is, as illustrated in FIG. 7B, the skew correction profile is set by multiplying a coefficient according to the skewing amount. The controller 260 drives the registration driving motors M1L and M1R according to the skew correction profile created in this manner. Thereby, as illustrated in FIG. 7C, a velocity difference is generated by the registration driving roller 212L rotated by the registration driving motor M1L and the registration driving roller 212R rotated by the registration driving motor M1R. Therefore, the sheet being conveyed by the registration driving rollers 212L and 212R is rotated, and skewing is corrected. An example in which a curve-line drive is used is illustrated as the example of the skew correction profile illustrated in FIG. 7B, but a triangular drive or a trapezoidal drive may also be adopted.

### Lateral Registration Displacement Correction Operation

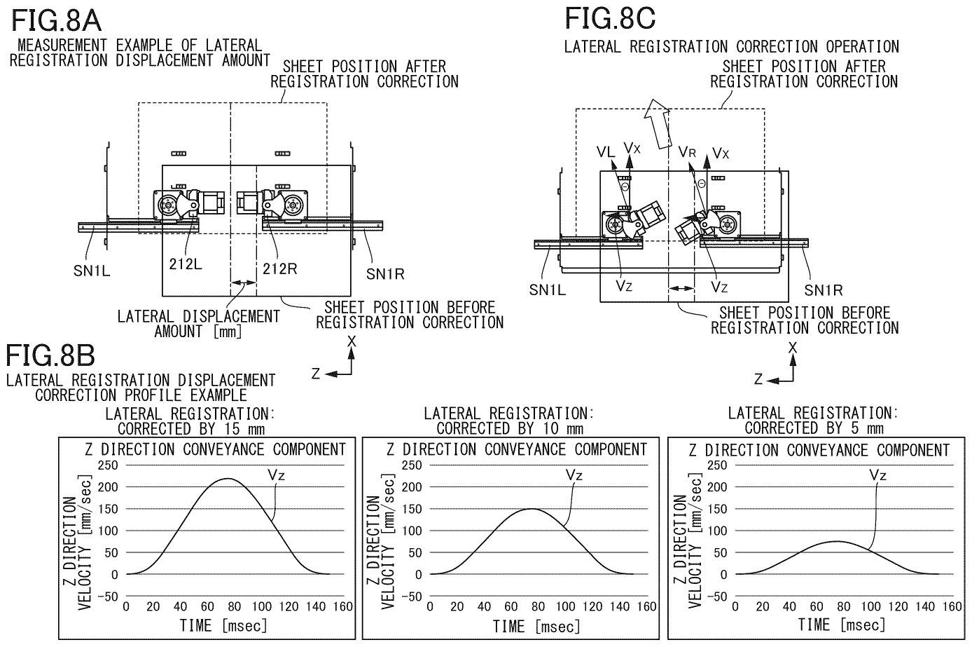

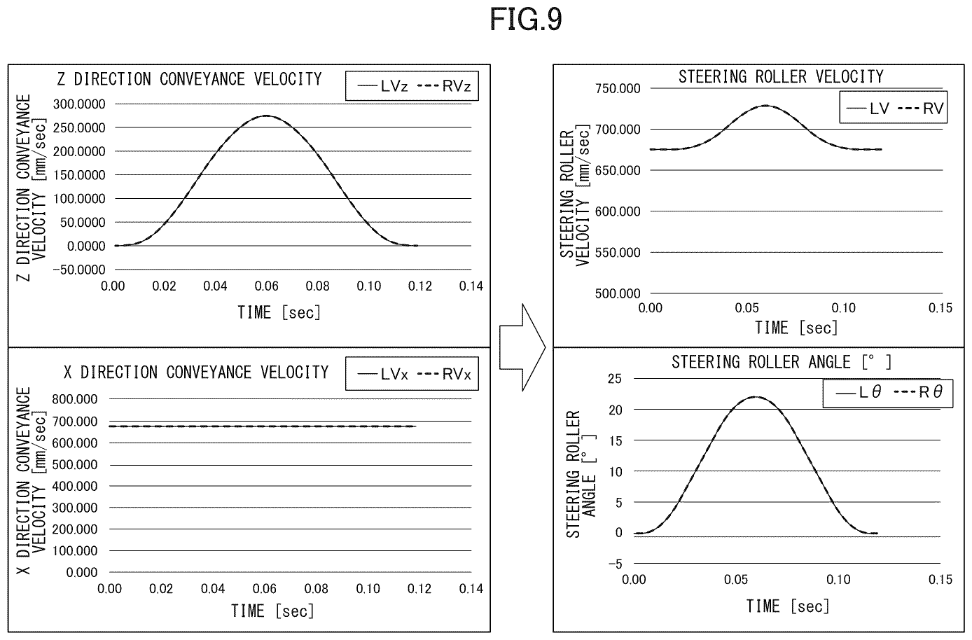

Next, a principle of a lateral registration displacement correction operation, i.e., steering operation, will be described with reference to FIGS. 8A, 8B, 8C, and 9. FIG. 8A is a schematic diagram illustrating a measurement example of a lateral registration displacement amount. FIG. 8B is a view illustrating an example of a lateral registration displacement correction profile. FIG. 8C is a schematic diagram illustrating a lateral registration displacement correction operation. FIG. 9 is a view illustrating an example of a correction profile when performing the lateral registration displacement correction.

An up-down direction in FIG. 8A is the conveyance direction X of the sheet, and a right-left direction in FIG. 8 is the width direction Z orthogonal to the conveyance direction X. The lateral registration displacement correction refers to performing correction such that the width direction position of the sheet is matched with a width direction position of the image to be formed, and in most cases, a center of the sheet in the width direction is made to correspond to a center of the conveyance path in the width direction, i.e., reference position. This is not the case if the width direction position of the image formed on the sheet in the image forming unit, i.e., the recording unit 230, does not correspond to the width direction center of the conveyance path.

As described above, the steering motors M2L and M2R can change the conveyance directions of rollers of each of the registration driving rollers 212L and 212R via the drive input gears 214L and 214R by pivoting the rollers about the steering shafts 215L and 215R. For example, if skew correction of the sheets is not performed, the registration driving rollers 212L and 212R are operated such that the velocities VL and VR thereof are the same and the conveyance directions thereof are also the same. Based on the edge portion positions of the sheet detected by the image sensors SN1L and SN1R, the controller 260 determines a profile as a control amount for correcting the lateral registration displacement. That is, the profile of the steering motors M2L and M2R for changing the conveyance direction of the registration driving rollers 212L and 212R is determined.

The profile of lateral registration displacement correction will be described. As illustrated in FIG. 8A, a lateral displacement amount, which is the positional displacement in the width direction Z, is detected by the image sensors SN1L and SN1R. Then, the controller 260 creates a profile of the lateral registration displacement correction, velocity of the Z direction component, as illustrated in FIG. 8B according to the detected lateral displacement amount. The profile of the lateral registration displacement correction is created as a velocity table such that the detected lateral displacement amount and an integrated value of a velocity Vz of the roller of the component in the width direction in a correction section set in advance are equivalent. That is, as illustrated in FIG. 8B, the profile of the lateral registration displacement correction is set by multiplying a coefficient corresponding to the lateral displacement amount.

If the lateral registration displacement correction and the skew correction are not performed simultaneously, it is preferable that a velocity Vx of the roller as a conveyance direction X component is set to be equal to a conveyance velocity of the print belt unit 220 arranged downstream in the conveyance direction X. Since the velocity Vx of the roller of the conveyance direction X component and the velocity Vz of the roller of the width direction Z component are determined, as illustrated in FIG. 8C, trigonometric function is used to compute a roller angle θ and a roller velocity V may be computed based on the velocity Vx and the velocity Vz. By computing each of the roller angles θL and θR and the velocities VL and VR per unit time, operation profile of the steering motors M2L and M2R and the registration driving motors M1L and M1R can be created as illustrated in FIG. 9. According to this profile, the steering motors M2L and M2R and the registration driving motors M1L and M1R can be driven. Thereby, as illustrated in FIGS. 4B, 5C, and 8C, the registration driving roller 212L is turned by the steering motor M2L and the registration driving roller 212R is turned by the steering motor M2R. Therefore, the registration driving rollers 212L and 212R convey the sheet diagonally, and the lateral registration displacement is corrected. An example illustrating a curve-line drive is illustrated as an example of velocity correction profile illustrated in FIG. 8B, but a triangular drive or a trapezoidal drive may also be used.

### Simultaneous Correction of Skew Correction and Lateral Registration Displacement Correction

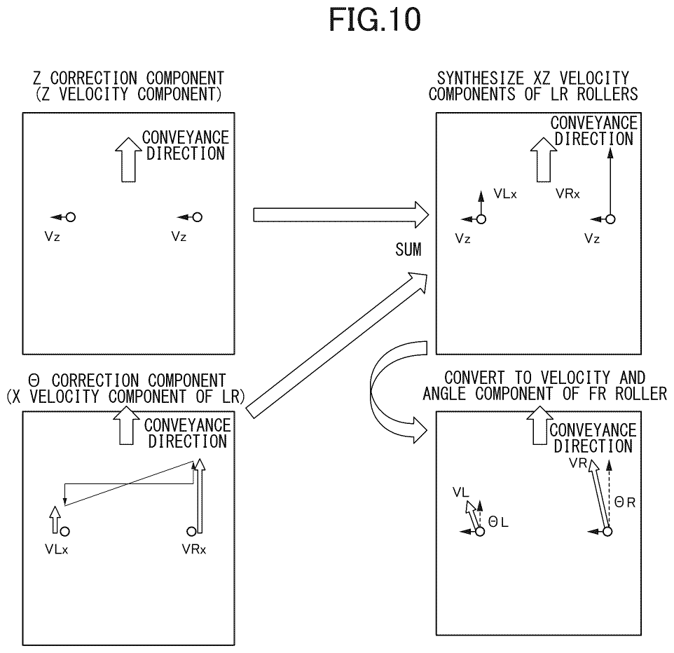

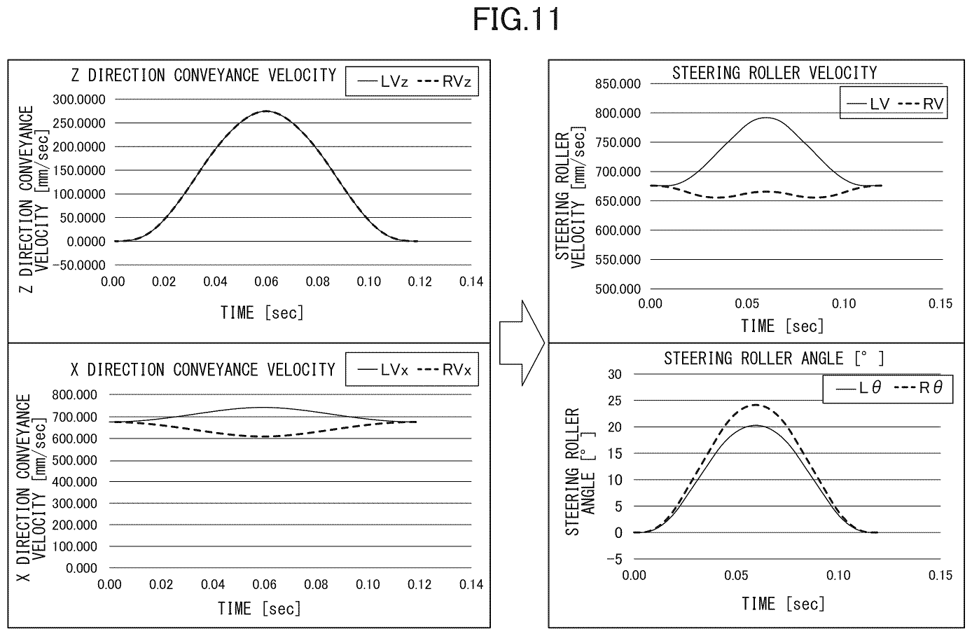

Next, a simultaneous correction of skew correction and lateral registration displacement correction will be described with reference to FIGS. 10 and 11. FIG. 10 is a view illustrating a conversion of velocity component and angle component of the registration driving roller in a state where skew correction and lateral registration displacement correction are performed simultaneously. FIG. 11 is a view illustrating an example of a correction profile in a case where the skew correction and the lateral registration displacement correction are performed simultaneously.

As described, above, skewing of the sheet is corrected by the velocity difference of the registration driving motors M1L and M1R, and skew correction can be performed thereby. Further, lateral registration displacement of the sheet is corrected by the registration driving rollers 212L and 212R being turned by the steering motors M2L and M2R, and thereby, lateral registration displacement correction is performed.

In the above description, the skew correction operation and the lateral registration displacement correction operation were described independently, but they can also be executed simultaneously. As illustrated in FIG. 10, by combining a component of lateral registration displacement in the width direction Z, i.e., Z correction component, and a component of the skewing amount, i.e., skewing angle, i.e., θ correction component, they can be converted into the velocities VL and VR and angle, i.e., steering angle, of each of the registration driving rollers 212L and 212R. In other words, as illustrated in FIG. 11, velocities LVz and RVz of the registration driving rollers 212L and 212R in the profile of lateral registration displacement correction and velocities LVx and RVx of the registration driving rollers 212L and 212R in the skew correction profile are combined. Roller angles Lθ and Rθ per unit time and the velocities VL and VR are calculated, and a simultaneous correction profile for executing skew correction and lateral registration displacement correction simultaneously is created. Then, according to the created simultaneous correction profile, the registration driving motors M1L and M1R and the steering motors M2L and M2R are driven. Thereby, skew correction and lateral registration displacement correction can be executed simultaneously.

### Detailed Configuration of Image Sensor (CIS) and Issues Thereof

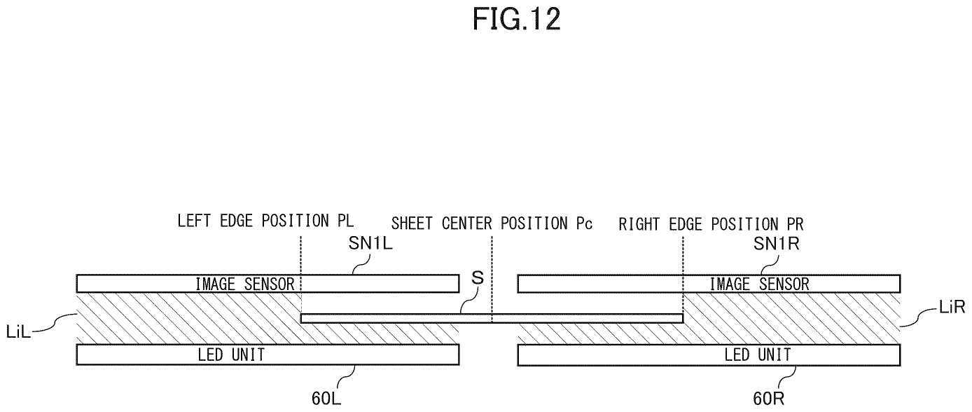

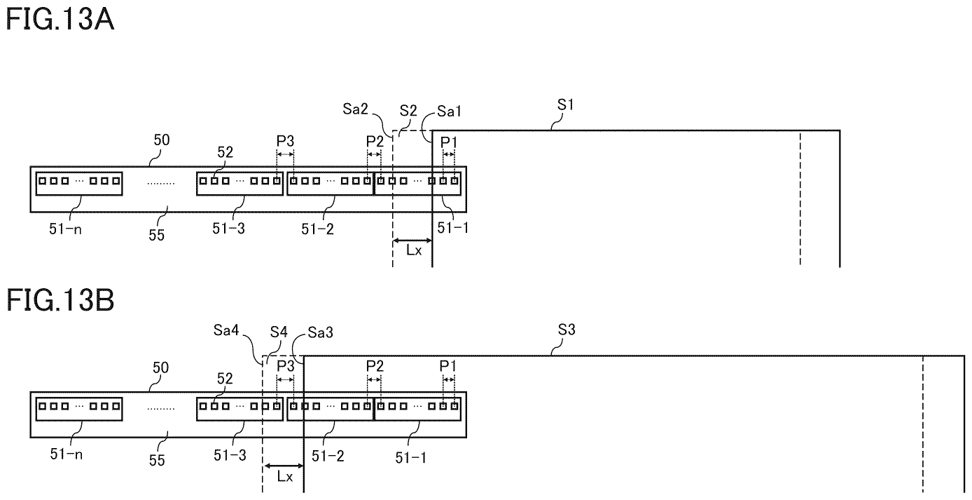

Next, a detailed configuration of the image sensors SN1L and SN1R serving as a CIS 50 will be described with reference to FIGS. 12 and 13. FIG. 12 is an explanatory view illustrating a detection operation of a side edge position of a sheet according to the image sensors of the present embodiment. FIG. 13A is a view illustrating a case in which a side edge position of a sheet is dispersed within a detection range of a single sensor chip in the CIS. FIG. 13B is a view illustrating a case in which a side edge position of a sheet is dispersed across different sensor chips in the CIS. The configuration of the CIS 50 is described assuming that the image sensors SN1L and SN1R are configured of line sensors of the same type, which are referred to as the CIS 50. Further according to the present embodiment, a light source unit 60 including LEDs as light sources is disposed as a separate member as the CIS 50, but alternatively, a light source may be disposed integrally in the CIS 50. Further according to the present embodiment, the image sensors SN1L and SN1R adopt CIS, but alternatively, the image sensors may adopt CCD.

### Principle of Side Edge Detection of Sheet by Image Sensors

As illustrated in FIG. 12, LED units 60L and 60R are arranged at positions facing each of the image sensors SN1L and SN1R. The LED units 60L and 60R adopt LED modules that include LEDs arranged on substrates not shown and that uniformly emit lights LiL and LiR uniformly toward the image sensors SN1L and SN1R respectively via light guides not shown.

In a state where the sheet S is passed between the image sensor SN1L and the LED unit 50L, the light LiL emitted from the LED unit 50L is blocked by the sheet S. By acquiring the light amount variation of the light LiL caused by blocking of light by the sheet S via the image sensor SN1L, a left edge position PL serving as a side edge of the sheet is detected. Similarly, in a state where the sheet S is passed between the image sensor SN1R and the LED unit 50R, the light LiR emitted from the LED unit 50R is blocked by the sheet S. By acquiring the light amount variation of the light LiR caused by blocking of light by the sheet S via the image sensor SN1R, a right edge position PR serving as a side edge of the sheet is detected. Then, based on the left edge position PL and the right edge position PR of the sheet S, the center position Pc of the sheet S can be computed.

### Detailed Configuration of CIS

As illustrated in FIGS. 13A and 13B, the CIS 50 includes a printed substrate 55, and a plurality of (n) sensor chips 51 arranged in the width direction Z on the printed substrate 55. Further, a plurality of light receiving elements 52 are arranged with equal spacings therebetween on the sensor chips 51.

### Issues

A pixel pitch P1, which is a spacing between the light receiving elements 52 arranged on the sensor chips 51, is 42.3 μm (micrometers) in a case where a resolution is 600 dpi. The sensor chips 51 are semiconductors, such that arrangement of spacing of the light receiving elements 52 is managed during manufacture in the order of nm (nanometers). Therefore, the dispersion of the pixel pitch P1 of the light receiving elements 52 disposed on the sensor chips 51 is managed during manufacture by an extremely small value with respect to the pixel pitch P1 of 42.3 μmin the case of a resolution of 600 dpi, such that the influence thereof on detection accuracy in the width direction Z is extremely small.

Meanwhile, the sensor chips 51 are mounted on the printed substrate 55 via a mounter, and in the case of a general mounter, a dispersion of mounting position in the order of approximately 70 to 100 μm occurs. Therefore, for example, a spacing of a pixel pitch P2 between sensor chips 51-1 and 51-2 may be a narrow pitch, such as 40 μm, or a spacing of a pixel pitch P3 between sensor chips 51-2 and 51-3 may be a wide pitch, such as 120 μm. In other words, as a manufacturing error, dispersion that may affect the detection accuracy in the width direction Z may occur regarding the pixel pitches crossing over different sensor chips 51.

As illustrated in FIG. 13A, it is assumed that a sheet S1 and a sheet S2 are conveyed within a dispersion range Lx as illustrated by solid lines and dotted lines. Then, a side edge Sa1 of the sheet S1 and a side edge Sa2 of the sheet S2 are detected within a detection range of a single sensor chip 51, that is, within a width of a single sensor chip 51. Therefore, these detection results are detected by a detection accuracy of an error range of 42.3 μm corresponding to the pixel pitch P1.

Meanwhile, as illustrated in FIG. 13B, it is assumed that a sheet S3 and a sheet S4 are conveyed within the dispersion range Lx across sensor chips 51-2 and 51-3, as illustrated by solid lines and dotted lines. That is, a side edge Sa3 of the sheet S3 and a side edge Sa4 of the sheet S4 are detected across the sensor chips 51-2 and 51-3. Therefore, these detection results are detected by a detection accuracy of an error range of 120 μm corresponding to the pixel pitch P3, as described above.

Therefore, compared to the detection accuracy of a case where the side edges Sa of multiple sheets S are detected by a single sensor chip 51 as illustrated in FIG. 13A, the detection accuracy of a case where the side edges Sa of multiple sheets S are detected across a plurality of sensor chips 51 as illustrated in FIG. 13B is deteriorated. Therefore, if lateral registration displacement correction, i.e., first correction control and second correction control described below, of the sheet S is executed based on this detection result, the positional accuracy of the sheet S in the width direction Z may not be good, and the positional accuracy of the image formed on the sheet S thereafter may also not be good.

Specifically, in the field of commercial printing and industrial printing, demands regarding the products are high, and the dispersion of left right end margins of the sheet S is required to be suppressed to 100 μm or smaller. Therefore, detection accuracy of CIS for detecting the position of the side edge Sa of the sheet S is required to be 50 μm or smaller. However, as illustrated in FIG. 13B, if the side edge Sa of the sheet S is detected across a plurality of sensor chips 51, the required specification cannot be satisfied due to the dispersion of mounting position, which is approximately 70 to 100 μm corresponding to the accuracy of the mounter. In other words, the positional accuracy of the sheet S subjected to lateral registration displacement correction will not be good, and the positional accuracy of the image formed on the sheet S will also not be good. Therefore, according to the present embodiment, this issue is solved by the method, or control, described below.

### Method of Lateral Registration Displacement Correction according to Present Embodiment

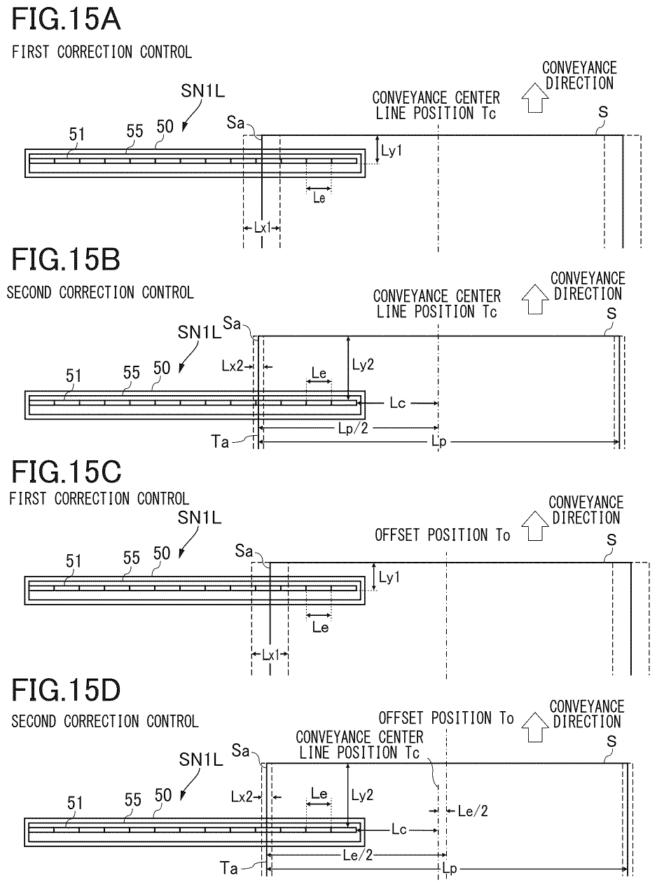

Next, a lateral registration displacement correction method of the sheet S according to the present embodiment will be described with reference to FIG. 15. FIG. 15A is an explanatory view illustrating a case in which a sheet position is moved using a conveyance center line position as a target in a first correction control. FIG. 15B is an explanatory view illustrating a case in which a sheet position is moved using the conveyance center line position as a target in a second correction control. FIG. 15C is an explanatory view illustrating a case in which a sheet position is moved using an offset position offset from the conveyance center line position as the target in the first correction control. FIG. 15D is an explanatory view illustrating a case in which a sheet position is moved using the offset position offset from the conveyance center line position as the target in the second correction control.

In the present embodiment, correction control of detecting the position of the side edge Sa of the sheet S and correcting the position of the sheet S using the detection result, i.e., skew correction and lateral registration displacement correction, is performed twice, which are the first correction control and the second correction control. In the second correction control, which is performed for the second time, if the side edge Sa of the sheet S can be detected by a single sensor chip 51, the accuracy of position of the sheet S whose position has been corrected by the second correction control will be good. The details of the correction control will be described below. In the following description, in order to simplify the description, the skew correction operation, i.e., skew correction profile, will be omitted, and description is provided assuming that only the lateral registration displacement correction operation is performed, that is, only the correction of profile of lateral registration displacement correction is performed.

FIGS. 15A and 15C illustrate positional relationships between a dispersion range Lx1 of the sheet S in the width direction Z and a spacing, i.e., node, between a plurality of sensor chips 51 in a state where the leading edge of the sheet S has been conveyed for a distance Ly1 after reaching the image sensor SN1L. FIGS. 15B and 15D illustrate a state in which lateral registration displacement correction has been performed from the state of FIG. 15A or FIG. 15C. That is, FIGS. 15B and 15D illustrate positional relationships between the dispersion range Lx1 of the sheet S in the width direction Z and the spacing between a plurality of sensor chips 51 in a state where the leading edge of the sheet S has been conveyed for a distance Ly2 after reaching the image sensor SN1L.

Usually, in lateral registration displacement correction, positioning of the sheet S and an image formed subsequently by the recording unit 230 is performed by moving the center position Pc of the sheet S in the width direction Z to a conveyance center line position Tc of the sheet conveyance path. That is, since a center position of the image formed by the recording unit 230 is matched with the conveyance center line position Tc, lateral registration displacement correction is performed such that the sheet S corresponds to the conveyance center line position Tc.

In FIGS. 15A and 15B, a case where dispersion of position of the side edge Sa of the sheet S detected by the image sensor Sn1L crosses a plurality of sensor chips 51 in the second correction control, i.e., second correction control, is illustrated. Whether the position of the side edge Sa of the sheet S crosses a plurality of sensor chips 51 is determined by the conveyance center line position Tc, a width Lp of the sheet S, the dispersion ranges Lx1 and Lx2 of the sheet S, and the position of the spacing, i.e., node, of the adjacent sensor chips 51. The conveyance center line position Tc, the dispersion ranges Lx1 and Lx2 of the sheet S, and the spacing of the plurality of sensor chips 51 is determined by product design. Therefore, whether the position of the side edge Sa of the sheet S is arranged across a plurality of sensor chips 51 can be determined based on the width Lp of the sheet S used by the user, that is, the sheet size information in the width direction Z. The sheet size information can be acquired, for example, based on information of the sheet set in the storages 110a, 110b, and 110c, or on information of the sheet contained in the print job, such as a sheet size information of a regular size sheet.

According to the CIS 50 of the present embodiment, 12 sensor chips 51 are arranged on a single printed substrate 55. Therefore, the position of spacing of the sensor chips 51 can be represented by “Lc+Le×n (n=0, 1, 2, . . . , 11)”, when Lc represents a distance from the conveyance center line position Tc to the first pixel of the image sensor SN1L, and Le represents a sensor chip width.

In a state where the center position Pc of the sheet S is at the conveyance center line position Tc, the position of the side edge Sa of the sheet S is at a width Lp/2 of the sheet S from the conveyance center line position Tc. Therefore, regarding the position of the side edge Sa of the sheet S in a state where the center position Pc of the sheet S is at the conveyance center line position Tc, it is possible to determine whether the position of spacing of the sensor chips 51 is within the dispersion ranges Lx1 and Lx2 of the sheet S. Thereby, it is possible to determine whether the dispersed position of the side edge Sa of the sheet S is arranged across a plurality of sensor chips 51.

As illustrated in FIG. 15A, before executing the first correction control, the sheet S conveyed from the feeding module 100 to the image sensor SN1L is conveyed with the conveyance center line position Tc set as a target position, and the sheet S is dispersed within the dispersion range Lx1 and reaches the image sensor SN1L. In the example, the dispersion range Lx1 refers to the dispersion of position of the sheet S from a state where the sheet S is fed from the feeding module 100 until the sheet S reaches the image sensor SN1L of the registration unit 210, and it is approximately ±15 mm. In the present embodiment, the sensor chip width Le is 20 mm, and in a state where the position of the sheet S is dispersed within the dispersion range Lx1, the position of the side edge Sa of the sheet S is detected across the spacing between a plurality of sensor chips 51. Therefore, the detection accuracy of position of the side edge Sa of the sheet S by the image sensor SN1L is deteriorated corresponding to the mounting error of the sensor chips 51 on the printed substrate 55.

As illustrated in FIG. 15B, before executing the second correction control, the sheet S corrected by the first correction control, i.e., first lateral registration displacement correction, is detected by the image sensor SN1L. In the case illustrated in FIG. 15B, the sheet S is conveyed with the conveyance center line position Tc set as the target position, and the position of the side edge Sa of the sheet S is dispersed within the dispersion range Lx2. The dispersion range Lx2 is a correction residue of the first correction control, i.e., first lateral registration displacement correction. The dispersion range Lx2 is determined based on the detection accuracy of position of the side edge Sa of the sheet S in the first correction control or the accuracy of turning angle of the steering motors M2L and M2R with respect to the conveyance direction, and it is approximately ±0.3 mm.

As illustrated in FIG. 15B, for example, in a state where the width size of the sheet S is the width Lp, when detecting the position of the side edge Sa of the sheet S in the second correction control, if the sheet position is dispersed within the dispersion range Lx2, the position will be disposed across a plurality of sensor chips 51. Therefore, in the second correction control, the detection result includes the mounting error of the sensor chips 51 to the printed substrate 55, such that the center position Pc of the sheet S cannot be moved to the conveyance center line position Tc with high accuracy.

Therefore, according to the present embodiment, as illustrated in FIG. 15C, in the first correction control, the conveyance center line position Tc is offset, i.e., shirted, in the width direction Z and set to a conveyance center line position Tc′. Thereby, as illustrated in FIG. 15D, in the second correction control, when detecting the position of the side edge Sa of the sheet S, the dispersion range Lx2 is not arranged across a plurality of sensor chips 51. That is, the position of the side edge Sa of the sheet S can be detected by the same single sensor chip 51. For example, if the conveyance center line position Tc is moved by a shift amount (Le/2)=10 mm and set to the conveyance center line position Tc′, even if the position of the side edge Sa of the sheet S is dispersed within the dispersion range Lx2, the position can be detected by the same single sensor chip 51. Then, according to the present embodiment, the offset portion of position of the sheet S in the width direction Z can be dealt with by offsetting the position of the image formed on the sheet S by the recording unit 230. The control of the registration unit 210 and the control of the recording unit 230 will be described in detail below.

### Operation, i.e., Control, of Registration Unit

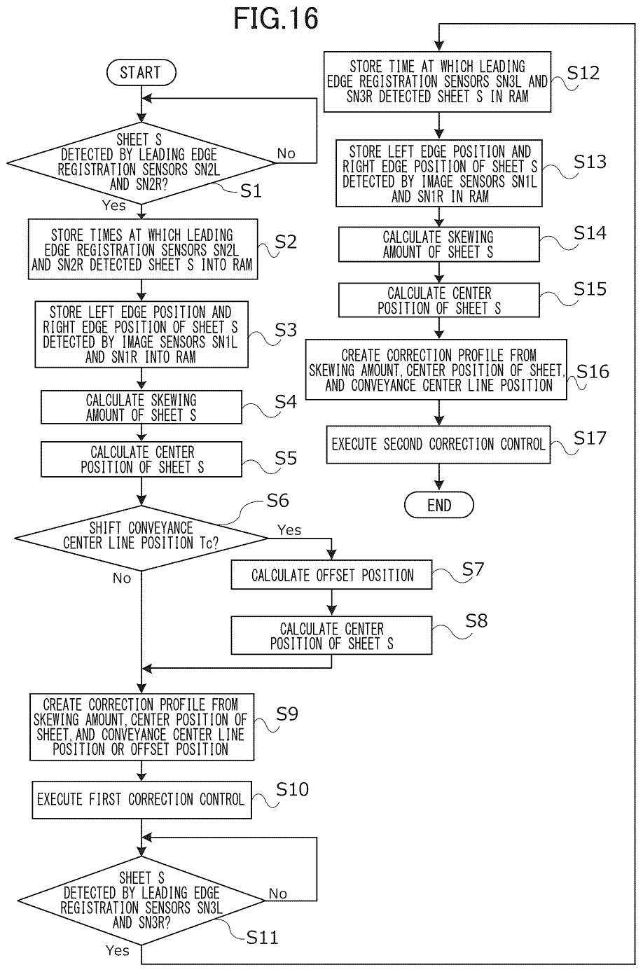

Next, the operation, i.e., control, of the registration unit 210 will be described with reference to FIG. 16. FIG. 16 is a flowchart of the control of the registration unit according to the present embodiment. In the control regarding image formation illustrated in FIG. 16, an example where an image is formed on one side of a sheet is described, but the present control is also performed repeatedly when forming images on both sides of a sheet.

### Start Printing

At first, the controller 260 starts control of image formation illustrated in FIG. 16 at a timing at which a print job has been received directly from an operation portion not shown or from an external computer connected via a network. The print job received by the controller 260 contains information such as a number of prints designated by the user, and the size of the sheet S subjected to printing. That is, the controller 260 determines to start printing according to the received print job.

Next, the controller 260 selects the sheet S having the size designated by the print job from the storages 110a, 110b, and 110c, and causes the sheet to be fed by the feeding module 100. Then, the controller 260 drives a driving motor to convey the sheet S by the conveyance roller pairs 208 and 209 (refer to FIG. 2) to the registration unit 210, and causes the sheet S to reach the registration roller pairs 240L and 240R.

### First Correction Control

Next, the controller 260, specifically, through computation of the CPU 261 to perform actual processing, proceeds to a series of processing of steps S1 to S10 as a first correction control, which is a correction control performed for the first time. At first, the controller 260 stands by until the sheet S reaches the leading edge registration sensors SN2L and SN2R (S1: No), and when the sheet S reaches the leading edge registration sensors SN2L and SN2R (S1: Yes), the procedure advances to step S2. Then, the controller 260 stores the times at which each of the leading edge registration sensors SN2L and SN2R has detected the leading edges of the sheet S into the RAM 263 (S2). Next, the controller 260 stores the left edge position PL and the right edge position PR of the sheet S detected by the image sensors SN1L and SN1R into the RAM 263 (S3).

Next, the controller 260 calculates and acquires the skewing amount of the sheet S based on the times at which the leading edge registration sensors SN2L and SN2R have detected the leading edges of the sheet S stored in the RAM 263 (S4). Specifically, the CPU 261 acquires the skewing amount of the sheet S based on a displacement of timing at which each of the two leading edge registration sensors SN2L and SN2R have detected the leading edges of the sheet S being conveyed and a velocity V, i.e., conveyance velocity, of the sheet S.

Next, the controller 260 calculates the width direction position of the sheet S, that is, the center position Pc of the sheet S, based on the detection result entered from the image sensors SN1L and SN1R (S5). Specifically, the CPU 261 calculates the center position Pc of the sheet S based on the left edge position PL and the right edge position PR of the sheet S.

The controller 260 determines whether to offset, i.e., shift, the conveyance center line position Tc (S6). Specifically, the CPU 261 determines whether to shift the conveyance center line position Tc based on the distance Lc from the conveyance center line position Tc to the first pixel of the image sensor SN1L, the sensor chip width Le, the width Lp of the sheet S, and the dispersion range Lx2 (refer to FIG. 15).

$$\vert Lp / 2 - ( Lc + Le \times n ) \vert < Lx 2$$

$$n = 0 , 1 , 2 … , 11$$

That is, as described above, after executing the first correction control, i.e., when performing detection of the second correction control, the controller 260 determines whether the dispersion range Lx2, i.e., first range, is overlapped with the spacing between a plurality of sensor chips 51. If the dispersion range Lx2 is not overlapped with the spacing between a plurality of sensor chips 51, it is determined that offset, i.e., shifting, of the of the conveyance center line position Tc is not performed (S6: No). In other words, in the width direction Z, in a case where the dispersion range Lx2, whose center is set to the position of the side edge Sa of the sheet S after movement, hereinafter referred to as a post-movement position, Ta when the center position Pc of the sheet S is moved to the conveyance center line position Tc, does not extend beyond the detection range, i.e., sensor chip width Le, of the sensor chip 51, the target position is set to the conveyance center line position Tc. That is, in the first correction control, the center position Pc of the sheet S is moved with the conveyance center line position Tc set as the target position, i.e., first target position.

Meanwhile, in a case where the dispersion range Lx2 is overlapped with the spacing between a plurality of sensor chips 51, it is determined that offset, i.e., shifting, of the conveyance center line position Tc is to be performed (S6: Yes). Then, at first, the controller 260 calculates the shift amount of the conveyance center line position Tc, that is, calculates the offset position by which the sheet S is to be offset (S7). In this example, the shift amount from the conveyance center line position Tc is +Le/2 or −Le/2. In other words, the offset position is a position offset, i.e., shifted, by ½ the distance of the width direction Z distance of the sensor chip 51, i.e., sensor chip width Le, from the conveyance center line position Tc. ½ the width direction Z distance of the sensor chip 51, i.e., sensor chip width Le, may also be referred to as ½ the detection range of the sensor chip 51.

Next, the controller 260 calculates the center position Pc of the sheet S (S8). The center position Pc of the sheet S can be expressed as

$$Pc = ( PL + PR ) / 2$$

wherein PL represents the left edge position and PR represents the right edge position. In other words, in the width direction Z, in a case where the dispersion range Lx2, whose center is set to a post-movement position Ta of the side edge Sa of the sheet S when the center position Pc of the sheet S is moved to the conveyance center line position Tc, extends beyond the detection range, i.e., sensor chip width Le, of the sensor chip 51, ½ the distance of the detection range, i.e., sensor chip width Le, from the conveyance center line position Tc is set as an offset position To moved toward the center of the detection range, i.e., sensor chip width Le. That is, in the first correction control, the center position Pc of the sheet S is moved with the offset position To set as the target position, i.e., first target position.

Next, the controller 260 creates a skew correction profile serving as a first control amount for correcting the skewing of the sheet S based on the skewing amount of the sheet S calculated as described above. Further, the controller 260 creates a lateral registration displacement correction profile serving as a first control amount for correcting lateral displacement of the sheet S. The lateral registration displacement correction profile for correcting the lateral displacement is created based on a distance from the center position Pc to the conveyance center line position Tc of the sheet S, or from the center position Pc to the offset position To (refer to FIG. 15) of the sheet S (S9).

Then, the controller 260 creates a correction profile having combined the skew correction profile and the lateral registration displacement correction profile, that is, creates a correction profile for the first correction control. Next, the controller 260 controls the registration driving motors M1L and M1R and the steering motors M2L and M2R according to the created correction profile. That is, the controller 260 controls the angles of the registration driving roller 212L and the registration driving roller 212R with respect to the conveyance direction while controlling the velocity difference thereof, to execute the first correction control serving as a correction operation of the first correction control (S10). The correction operation of the first correction control is executed so as to be completed in the first correction section CS1 (refer to FIGS. 2 and 3). Thereby, skewing and lateral displacement of the sheet is roughly adjusted.

### Second Correction Control

Next, the controller 260 proceeds to a series of processing of steps S11 to S17 as a second correction control, which is a correction control performed for the second time. At first, the controller 260 stands by until the sheet S reaches the leading edge registration sensors SN3L and SN3R (S11: No), and when the sheet S reaches the leading edge registration sensors SN3L and SN3R (S11: Yes), the procedure advances to step S12. The second correction control is executed after executing the first correction control and before the trailing edge of the sheet S passes through the registration driving roller 212L and the registration driving roller 212R.

At first, the controller 260 stores the times at which the leading edge registration sensors SN3L and SN3R have detected the leading edges of the sheet S into the RAM 263 (S12). Next, the controller 260 stores the left edge position PL and the right edge position PR of the sheet S detected by the image sensors SN1L and SN1R into the RAM 263 (S13). That is, the detection results entered from the image sensors SN1L and SN1R are controlled such that the dispersion range Lx2 falls within a single sensor chip 51 by the first correction control. Therefore, the detection result has a preferable accuracy that does not contain errors of spacing between the sensor chips 51.

Next, the controller 260 calculates and acquires the skewing amount of the sheet S based on the times at which the leading edge registration sensors SN3L and SN3R have detected the leading edges of the sheet S stored in the RAM 263 (S14). Next, the controller 260 calculates the center position Pc of the sheet S based on the detection result entered from the image sensors SN1L and SN1R (S15).

Thereafter, the controller 260 creates a skew correction profile serving as a second control amount for correcting skewing of the sheet S based on the skewing amount of the sheet S acquired as described above. Further, the controller 260 creates the lateral registration displacement correction profile serving as a second control amount for correcting the lateral displacement of the sheet S. The lateral registration displacement correction profile for correcting the lateral displacement is created based on a distance from the center position Pc of the sheet S to the conveyance center line position Tc, or from the center position Pc of the sheet S to the offset position To (refer to FIG. 15) (S16). In other words, in the second correction control, in a case where the conveyance center line position Tc is set as the target position, i.e., first target position, in the first correction control, the conveyance center line position Tc is set as the target position, i.e., second target position, and the center position Pc of the sheet S is moved. Further, when the offset position To is set as the target position, i.e., first target position, in the first correction control, the offset position To is set as the target position, i.e., second target position, and the center position Pc of the sheet S is moved.

Then, the controller 260 creates a correction profile having combined the skew correction profile and the lateral registration displacement correction profile, that is, creates a correction profile for the second correction control. Next, the controller 260 controls the registration driving motors M1L and M1R and the steering motors M2L and M2R according to the created correction profile. That is, the controller 260 controls the angles of the registration driving roller 212L and the registration driving roller 212R with respect to the conveyance direction while controlling the velocity difference thereof, to execute the second correction control serving as a correction operation of the correction control performed for the second time (S17). The correction operation of the second correction control is executed so as to be completed in the second correction section CS2 (refer to FIGS. 2 and 3). Thereby, skewing and lateral displacement of the sheet are subjected to fine adjustment.

According to the second correction control executed as described above, the lateral registration displacement correction of the sheet serving as rough adjustment in the first correction control is already executed. Therefore, as illustrated in FIG. 15B, the side edges of the plurality of sheets being conveyed in a laterally displaced or skewed manner are detected by a single sensor chip 51 of each of the image sensors SN1L and SN1R in a state where the lead edges of the sheet have reached the leading edge registration sensors SN3L and SN3R. Therefore, in the second correction control, the side edge positions of the sheet S detected by the image sensors SN1L and SN1R are detected as detection results with a preferable accuracy that does not include spacing errors of the sensor chips 51. Then, based on the detection result, lateral registration displacement correction profile of the second correction control is created. According thereto, lateral registration displacement correction of the sheet S is performed with a preferable accuracy, and the position of the sheet S in the width direction Z is subjected to fine adjustment.

### Operation, i.e., Control, of Recording Unit

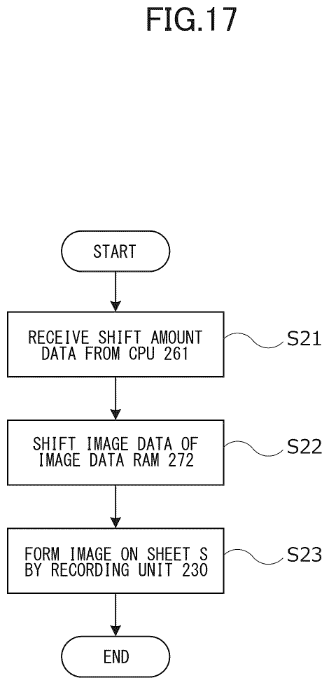

Next, the operation of the recording unit 230 for forming an image on the sheet S subjected to first correction control and second correction control in the registration unit 210 as described above will be described with reference to FIG. 17. FIG. 17 is a flowchart illustrating the control of a recording unit according to the present embodiment.

As illustrated in FIG. 17, at first, the image control CPU 271 (refer to FIG. 14) communicates with the CPU 261, and in a case where it is determined in the above-described step S6 that the conveyance center line position Tc is to be shifted, receives a shift amount in which the conveyance center line position Tc is shifted to the offset position To. If it is determined in step S6 that the conveyance center line position Tc is not to be shifted, the shift amount of “0 ” is received.

Next, the image control CPU 271 shifts the image data stored in the image data RAM 272 based on the received shift amount (S22). Specifically, image data is read out after displacing the image data corresponding to the shift amount based on a main scanning synchronizing signal, which is the read out timing of the image data. If it is determined in step S6 that the conveyance center line position Tc is not to be shifted, shifting of the image data is not performed, that is, the image data is read out without displacing the image data.

Then, the image control CPU 271 reads out the image data processed in step S22, transmits the image data to the recording unit 230, and executes image formation to the sheet S (S23). Thereafter, for example, the sheet S is discharged toward the discharging module 700 (refer to FIG. 1), ends the print job, and ends the image formation operation for a single sheet. In the case of duplex printing in which image formation is performed to both sides, a front surface and a rear surface, of the sheet S, after the operation of step S23, the controller 260 reverses the sheet S at the reversing module 600, and re-conveys the sheet S toward the registration roller pairs 240L and 240R. The operation performed to the front surface of the sheet described above is performed similarly to the rear surface of the sheet.

### Dispersion of Sheet Size in Width Direction

In the above-described control of the registration unit 210, a case has been illustrated where the sheet S is conveyed in a dispersed manner within the dispersion range Lx2, i.e., first range, with respect to the width direction Z (refer to FIG. 15). However, there is a tolerance in the size in the width direction Z of the sheet S conveyed to the registration unit 210. For example, based on JIS standard, the tolerance in size in the width direction Z is 2 mm. Therefore, depending on the size of the sheet S, the side edge Sa of the sheet S may be detected across a plurality of sensor chips 51 of the CIS 50 due to the tolerance.

Therefore, in the above-mentioned step S6, it may be possible to determine whether the side edge Sa of the sheet S is detected across a plurality of sensor chips 51 according to the tolerance of the sheet S, and to determine whether to offset the conveyance center line position Tc according thereto. In this case, by substituting the dispersion range Lx2 described above as a second range with a width size tolerance of the sheet S, a similar determination, or calculation, can be performed. The position of the dispersion range Lx2 in the width direction Z is determined by the width Lp of the sheet S, and the value thereof can be acquired based on a regular sheet size information. The regular sheet size, for example, in the order of the sheet having a smaller width direction Z size, are a postcard, a legal (G-LGL), FPLIO, B5, LETTER, A4/A3(landscape orientation), and B3.

In the description, the range of dispersion of the sheet S by conveyance and the range of dispersion of the sheet S based on the width size tolerance are described as the dispersion range Lx2. However, the dispersion ranges described above are not of the same range. That is, if the dispersion range of the sheet S in the width direction Z by conveyance is referred to as the first range, the dispersion range by tolerance may be referred to as the second range.

As for the dispersion of position of the side edge Sa of the sheet S based on the width size tolerance of the sheet described above, operations, or control, other than those described above are similar to the operation, or control, of the registration unit 210 described above, such that descriptions thereof are omitted.

### Summary of Present Embodiment

As described above, according to the present embodiment, the controller 260 executes the first correction control by the registration unit 210, and after the first correction control, executes the second correction control by the registration unit 210. Then, it is assumed that in the second correction control, it is determined that the positions of side edge Sa of the plurality of sheets S are in a state detected by different sensor chips 51 on the CIS 50. In this case, before executing the first correction control, the target position for moving the center position Pc of the sheet S is set to the position where the edge portions of a plurality of sheets are positioned within the detection range of a single sensor chip. Specifically, if the positions of side edges Sa of a plurality of sheets S are in a state detected by different sensor chips 51 on the CIS 50, the target position for moving the sheet S by the first correction control is set to the offset position To offset from the conveyance center line position Tc. Accordingly, the position of the sheet S is moved by the registration roller pairs 240R and 240L according to the first correction control, such that the side edges Sa of a plurality of sheets S are positioned within the detection range of a single sensor chip 51.

Then, in the second correction control, the position of the side edge Sa of the sheet S moved by the first correction control is detected by a single sensor chip 51, and according to the detection result thereof, the position of the sheet S is moved by the registration roller pairs 240R and 240L. Thereby, according to the second correction control, it is possible to acquire detection results of the positions of side edges Sa of a plurality of sheets S with a preferable accuracy with the positions not detected across different sensor chips 51 and that does not contain spacing error of sensor chips 51. Accordingly, in the second correction control, lateral registration displacement correction of a plurality of sheets S can be performed with a preferable accuracy toward the target position, and the positions of the sheets S in the width direction Z can be corrected preferably. Then, thereafter in the recording unit 230, the image forming position is offset according to the offset position To, i.e., shift amount, being offset, that is, image is formed on the sheet S according to the target position of the second correction control. Thereby, positional accuracy of the image formed on the sheet S can be made preferable. Therefore, the dispersion of the left end margin and the right end margin in the sheet S can be suppressed to 100μm or smaller.

### Other Embodiments

According to the present embodiment described above, an example in which the center position Pc of the sheet S is moved to the same target position, that is, to the conveyance center line position Tc or to the offset position To, in the first correction control and the second correction control have been described. However, the present technique is not limited thereto, and it may be possible to move the center position Pc of the sheet S to the conveyance center line position Tc or the offset position To as a first target position in the first correction control, and to set a second target position that differs from the first target position and move the center position Pc of the sheet S to that position in the second correction control. In that case, the position for forming the image on the sheet S by the recording unit 230 is a position corresponding to the second target position.

According further to the present embodiment, an example in which the skewing amount of the sheet is detected using the leading edge registration sensors SN2L and SN2R and the leading edge registration sensors SN3L and SN3R has been described. However, the present technique is not limited thereto, and it may be possible to use any configuration such as a configuration of imaging and analyzing the image, as long as the skewing amount of the sheet can be detected. Furthermore, the leading edge registration sensors SN2L and SN2R and the leading edge registration sensors SN3L and SN3R as sensors for detecting the skewing amount of the sheet are not limited to the arrangement illustrated in FIG. 2, and may be arranged in any position.

According further to the present embodiment, an example in which side edges Sa on either side of the sheet S are detected by arranging the image sensors SN1L and SN1R, but the present technique is not limited thereto, and the image sensor may be arranged only on one side to detect only one of the side edges Sa.

According further to the present embodiment, an example in which both skew correction and lateral registration displacement correction are carried out has been described. However, the present technique is not limited thereto, and it may be possible to have only the lateral registration displacement correction performed. Further, lateral registration displacement correction means correcting the position of the sheet in the width direction, but the present technique is not limited thereto, and the position of the sheet may be moved, or shifted. In other words, according to the present embodiment, instead of performing the first correction control and the second correction control, it may be possible to execute the first movement process and the second movement process that perform only movement in the width direction.

The present disclosure can also be realized by providing a program that realizes one or more functions of the above-described embodiments via a network or a storage medium to a system or apparatus, and wherein one or more processors of a computer in the system or the apparatus reads out and executes the processing of the program. Further, the present disclosure can also be realized by a circuit (such as ASIC) for performing one or more functions of the above-described embodiments.

According to the present disclosure, the positional accuracy of the image formed on the sheet can be enhanced.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-008420, filed Jan. 21, 2025, which is hereby incorporated by reference herein in its entirety.

What is claimed is:

1. A sheet conveyance apparatus comprising:
a moving unit including a roller configured to convey a sheet, the moving unit being configured to move a position of the sheet in a width direction orthogonal to a conveyance direction;
a width position detection unit including a plurality of sensor chips aligned in the width direction, each sensor chip including a plurality of light receiving elements, the width position detection unit being configured to detect a position of an edge portion of the sheet in the width direction; and
a control unit,
wherein, in a case where a side edge of a sheet is positioned within a detection range of a single sensor chip in a state where a reference position of the sheet is moved to a first target position of a sheet conveyance path in the width direction, the control unit is configured to move the reference position of the sheet toward the first target position by the moving unit according to the detection result of the width position detection unit,
wherein, in a case where a side edge of a sheet is not positioned within a detection range of a single sensor chip in a state where a reference position of the sheet is moved to the first target position, the control unit is configured to move the reference position of the sheet toward a second target position offset from the first target position by the moving unit according to the detection result of the width position detection unit, and
wherein the second target position is a position where the edge portion of the sheet is positioned within the detection range of a single sensor chip.

2. The sheet conveyance apparatus according to claim 1,
wherein the first target position is set according to a first range in which positions of edge positions of a plurality of sheets being conveyed are dispersed in the width direction.

3. The sheet conveyance apparatus according to claim 2,
wherein the reference position of a sheet is a center of the sheet,
wherein, in a case where the first range, whose center is set to a post-movement position of a side edge of a sheet when the center of the sheet is moved to a conveyance center line of the sheet conveyance path, does not extend beyond a detection range of a single sensor chip, the first target position is set to the conveyance center line, and
wherein, in a case where the first range, whose center is set to a post-movement position of a side edge of a sheet when the center of the sheet is moved to the conveyance center line of the sheet conveyance path, extend beyond a detection range of a single sensor chip in the width direction, an offset position in which ½ of a distance of the detection range is moved from the conveyance center line toward a center of the detection range is set as a second target position.

4. The sheet conveyance apparatus according to claim 3,
wherein the post-movement position is set based on a width size information of a sheet.

5. The sheet conveyance apparatus according to claim 1,
wherein the first target position is set according to a second range that is a range of tolerance of a width size of the sheet being conveyed.

6. The sheet conveyance apparatus according to claim 5,
wherein the reference position of a sheet is a center of the sheet,
wherein in a case where the second range, whose center is set to a post-movement position of a side edge of a sheet when the center of the sheet is moved to a conveyance center line of the sheet conveyance path, does not extends beyond a detection range of a sensor chip in the width direction, the first target position is set to the conveyance center line, and
wherein in a case where the second range, whose center is set to a post-movement position of a side edge of a sheet when the center of the sheet is moved to the conveyance center line of the sheet conveyance path, extends beyond a detection range of a sensor chip in the width direction, an offset position in which ½ a distance of the detection range is moved from the conveyance center line toward a center of the detection range is set as a second target position.

7. The sheet conveyance apparatus according to claim 6,
wherein the post-movement position is set based on a width size information of a sheet.

8. The sheet conveyance apparatus according to claim 1,
wherein the width position detection unit is a first width position detecting sensor disposed on one side in the width direction with respect to a conveyance center line of the sheet conveyance path, and
wherein the sheet conveyance apparatus further comprises a second width position detecting sensor disposed on the other side in the width direction with respect to the conveyance center line, the second width position detecting sensor including a plurality of sensor chips aligned in the width direction, each sensor chip including a plurality of light receiving elements, the second width position detecting sensor being configured to detect a position of an edge portion of the sheet in the width direction.

9. The sheet conveyance apparatus according to claim 1,
further comprising a skew detection unit configured to detect a skewing amount of a sheet conveyed to the moving unit,
wherein the moving unit is a correction unit configured to execute a first correction control and a second correction control each of which includes a skew correction of correcting skewing of a sheet while conveying the sheet, and a width position correction of correcting a position of the sheet in the width direction, and
wherein the control unit is configured to execute the first correction control the correction unit according to a detection result of the skew detection unit and the width position detection unit, and configured to execute the second correction control by the correction unit after executing the first correction control.

10. The sheet conveyance apparatus according to claim 9,
wherein the skew detection unit includes
a first skewing amount detection unit configured to detect a skewing amount of a sheet passing through the correction unit, and
a second skewing amount detection unit arranged downstream of the first skewing amount detection unit in the conveyance direction and configured to detect a skewing amount of the sheet passing through the correction unit,
wherein the width position detection unit detects the position of the sheet passing through the correction unit in the width direction, and
wherein the control unit is configured to
execute a first correction control by the correction unit according to a position of the sheet in the width direction detected by the width position detection unit and a skewing amount of the sheet detected by the first skewing amount detection unit, and
execute a second correction control by the correction unit according to a position of the sheet in the width direction detected by the width position detection unit and a skewing amount of the sheet detected by the second skewing amount detection unit.

11. The sheet conveyance apparatus according to claim 10,
wherein the correction unit includes
a first skew correction roller configured to turn about an axis in an intersecting direction intersecting the conveyance direction and the width direction and to convey a sheet,
a first rotational driving motor configured to drive the first skew correction roller to rotate,
a first turning motor configured to drive the first skew correction roller to turn,
a second screw correction roller configured to turn about an axis in the intersecting direction and to convey the sheet,
a second rotational driving motor configured to drive the second screw correction roller to rotate, and
a second turning motor configured to drive the second screw correction roller to turn, and
wherein the control unit is configured to
perform the skew correction by generating a velocity difference between the first skew correction roller driven by the first rotational driving motor to rotate and by the second screw correction roller driven by the second rotational driving motor to rotate, and
perform the width position correction by turning the first skew correction roller by the first turning motor and turning the second screw correction roller by the second turning motor.

12. The sheet conveyance apparatus according to claim 11,
wherein the control unit executes the second correction control after executing the first correction control and before a trailing edge of a sheet passes through the first skew correction roller and the second screw correction roller.

13. The sheet conveyance apparatus according to claim 1,
wherein the width position detection unit is configured of a contact image sensor.

14. The sheet conveyance apparatus according to claim 1,
wherein, in a case where a side edge of a sheet is positioned within a detection range of a single sensor chip when a reference position of a sheet is moved to the first target position, the control unit is configured to
execute a first processing of moving a reference position of a sheet toward a first target position by the moving unit such that an edge portion of the sheet is positioned within a detection range of a first sensor chip according to a detection result of the width position detection unit, and
after the first processing, execute a second processing of moving a reference position of a sheet by the moving unit toward a first target position according to a detection result of the width position detection unit obtained after the first processing,
wherein, in a case where a reference position of a sheet is moved to the first target position, if the side edge of the sheet is not positioned within a detection range of a second sensor chip,
the control unit is configured to execute a third processing of moving a reference position of a sheet by the moving unit toward a second target position offset from a first target position such that an edge portion of the sheet is positioned within a detection range of the second sensor chip according to a detection result of the width position detection unit, and
after the third processing, the control unit is configured to execute a fourth processing of moving the reference position of the sheet by the moving unit toward the second target position according to a detection result of the width position detection unit obtained after the third processing.

15. An image forming apparatus comprising:
the sheet conveyance apparatus according to claim 1, and
an image forming unit configured to form an image on a sheet,
wherein, in a case where a side edge of a sheet is not positioned within a detection range of a single sensor chip in a state where a reference position of the sheet is moved to the first target position, the image forming unit is configured to form an image on a sheet according to the second target position.

16. An image forming system comprising:
the sheet conveyance apparatus according to claim 1, and
a processing apparatus configured to provide processing to a sheet on which an image has been formed by an image forming apparatus.
